(19) United States
(12) Patent Application Publication
(10) Pub. No.: US 2026/0192191 A1
(43) Pub. Date: Jul. 9, 2026

(54) IMAGE PROCESSING SYSTEM, IMAGE PROCESSING METHOD, AND PROGRAM

(71) Applicant: Sony Interactive Entertainment Inc., Tokyo (JP)

(72) Inventors: Hirotaka Asayama, Kanagawa (JP); Ryota Ito, Kanagawa (JP); Shoichi Ikenoue, Chiba (JP)

(21) Appl. No.: 19/552,699

(22) Filed: Feb. 27, 2026

Related U.S. Application Data
(63) Continuation of application No. PCT/JP2024/030167, filed on Aug. 26, 2024.

(30) Foreign Application Priority Data
Sep. 4, 2023 (JP) 2023-143030

(51) Int. Cl. A63F 13/25; G06T 3/40; G06T 5/60; G06T 5/70; G06T 7/246; G06T 7/55; G06T 15/20

(52) U.S. Cl. CPC A63F 13/25; G06T 3/40; G06T 5/60; G06T 5/70; G06T 7/248; G06T 7/55; G06T 15/20; G06T 2207/20081; G06T 2207/20084; G06T 2207/30168

(57) ABSTRACT

Provided is an image processing system that improves time-series stability while maintaining spatial accuracy. An image processing system including at least one processor inputs first through n-th input frames (n is a natural number equal to or greater than 2) to a machine learning model and acquires each of first through n-th estimated frames (26). The at least one processor acquires each of first through n-th processing target frames (20), acquires (n−1)-th accumulated feature information (28) that indicates the features of the first through (n−1)-th input frames (24) and that is output from the machine learning model, acquires (n−1)-th auxiliary information (30) in reference to the (n−1)-th accumulated feature information (28), and acquires the n-th input frame (24) that has, for each pixel, information elements greater in number than information elements that the n-th processing target frame (20) has for each pixel, in reference to the n-th processing target frame (20) and the (n−1)-th auxiliary information 30.

### CROSS-REFERENCE TO RELATED APPLICATIONS

This application is a Continuation of International Application No. PCT/JP2024/030167, having an International Filing Date of Aug. 26, 2024, which claims the benefit of Japanese Application No. 2023-143030 filed Sep. 4, 2023. This disclosure of the prior application is considered part of the disclosure of this application.

The present specification relates to an image processing system, an image processing method, and a program.

“Super resolution” is a technology that estimates a high quality image in reference to a low quality image with the use of a machine learning model.

### SUMMARY

This specification describes a system having a recursive configuration that improves the image quality of a current frame (n-th frame) by inputting, to a machine learning model, the n-th frame and information indicating features of past frames (first through (n−1)-th frames), in order to realize super resolution for moving images such as a game screen.

In the abovementioned system, increasing the number of information elements that the frame to be input to the machine learning model has for each pixel improves time-series stability and allows smooth and sequential display of the plurality of frames.

However, increasing the number of information elements that the frame to be input has leaves no choice but to reduce the pixel count, to suppress the processing load. A smaller pixel count of the frame to be input has a risk of resulting in lower spatial accuracy in the frame to be output.

The present specification has an object to provide an image processing system, an image processing method, and a program that improve time-series stability while maintaining spatial accuracy.

An image processing system according to the present specification is an image processing system that inputs first through n-th input frames (n is a natural number equal to or greater than 2) to a machine learning model and acquires each of first through n-th estimated frames. The image processing system includes at least one processor, and the at least one processor acquires each of first through n-th processing target frames, acquires (n−1)-th accumulated feature information that indicates features of the first through (n−1)-th input frames and that is output from the machine learning model, acquires (n−1)-th auxiliary information in reference to the (n−1)-th accumulated feature information, and acquires the n-th input frame that has, for each pixel, information elements greater in number than information elements that the n-th processing target frame has for each pixel, in reference to the n-th processing target frame and the (n−1)-th auxiliary information.

### BRIEF DESCRIPTION OF THE DRAWINGS

FIG. 1 is a diagram illustrating an example of a hardware configuration of an image processing system.

FIG. 2 is a diagram illustrating an outline of the image processing system.

FIG. 3 is a functional block diagram illustrating an example of functions implemented by the image processing system.

FIG. 4 is a diagram describing processing in a rendering section.

FIG. 5 is a diagram describing processing in an intermediate frame acquiring section.

FIG. 6 is a diagram schematically describing generation of an input frame in an input frame acquiring section.

FIG. 7A is a flowchart illustrating an example of a flow of processing executed in the image processing system.

FIG. 7B is a flowchart illustrating an example of a flow of processing executed in the image processing system.

### DETAILED DESCRIPTION

One example of an implementation of an image processing system according to the present specification is hereinafter described with reference to the drawings.

### 1. Hardware Configuration Of Image Processing System

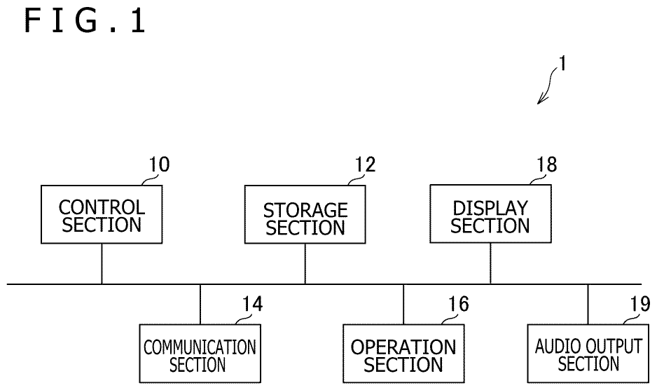

FIG. 1 is a diagram illustrating an example of a hardware configuration of an image processing system 1. The image processing system 1 is, for example, a computer such as a game console (game machine). As illustrated in FIG. 1, the image processing system 1 includes a control section 10, a storage section 12, a communication section 14, an operation section 16, a display section 18, and an audio output section 19.

The control section 10 includes, for example, a program control device such as a central processing unit (CPU) that operates in accordance with a program installed in the image processing system 1. Moreover, the control section 10 also includes a graphics processing unit (GPU) that draws an image in a frame buffer in reference to a graphics command or data supplied from the CPU.

The storage section 12 includes, for example, a main storage device such as a read only memory (ROM) and a random access memory (RAM) and an auxiliary storage device such as a hard disk drive (HDD) and a solid state drive (SSD). The storage section 12 stores therein programs executed by the control section 10, for example. The storage section 12 stores, for example, game programs (game software) in addition to programs for implementing various functions of the image processing system 1 that are to be described later. Moreover, in the storage section 12, an area for a frame buffer in which an image is drawn by the GPU is reserved.

The communication section 14 is, for example, a communication interface such as an Ethernet (registered trademark) module, a wireless local area network (LAN) module, and the like.

The operation section 16 is a user interface such as a keyboard, a mouse, and a controller of a game console, receives operation input made by the user, and outputs a signal indicating contents of the input to the control section 10.

The display section 18 is a display device such as a liquid crystal display and an organic electroluminescence (EL) display and displays various kinds of images in accordance with the instructions given by the control section 10.

The audio output section 19 is, for example, a speaker and outputs audio indicated by the audio data generated by the image processing system 1.

Note that the image processing system 1 may, in addition to the devices described above, include an optical disk drive that reads an optical disk such as a digital versatile disc-ROM (DVD-ROM) and a Blu-ray (registered trademark) disc, a universal serial bus (USB) port, and the like.

### 2. Outline of Image Processing System

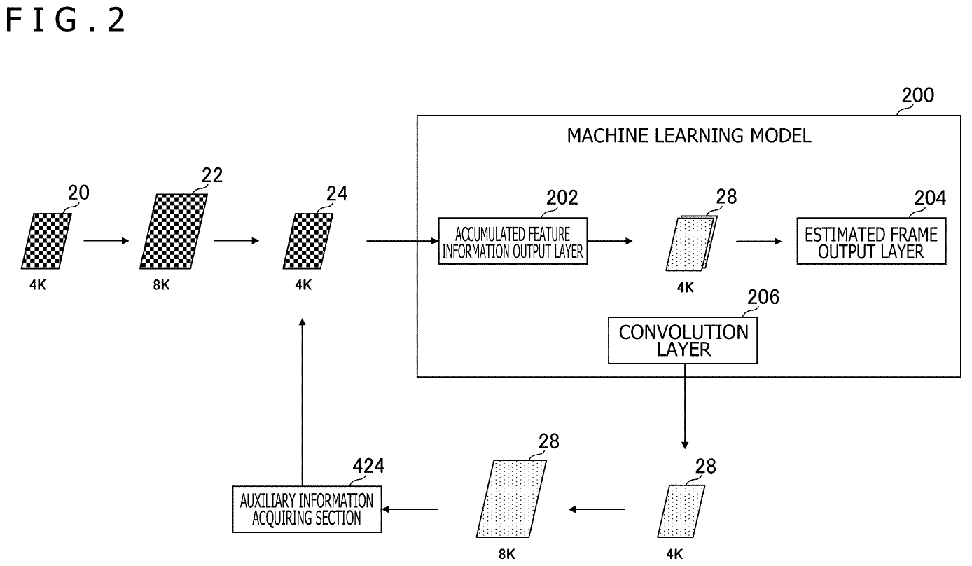

FIG. 2 is a diagram illustrating an outline of the image processing system 1. Here, a case where the image processing system 1 is used for improving quality of gameplay moving images in a game is illustrated. Gameplay moving images are moving images generated according to the game program executed by the control section 10, user input received by the operation section 16, and the like. Gameplay moving images include a plurality of still images (frames) that are time-series data. The processing executed in the image processing system 1 is mainly as follows.

### (1) Generation of Processing Target Frame

First, the image processing system 1 generates an image (processing target frame) in which one or more game objects are drawn, by executing rendering of three-dimensional data indicating the game objects as viewed from a predetermined viewpoint. The processing target frame is an image having a predetermined initial pixel count and a predetermined initial image quality. The initial pixel count is, for example, 3840×2160 (hereinafter, the pixel count is sometimes simply indicated as “4K”).

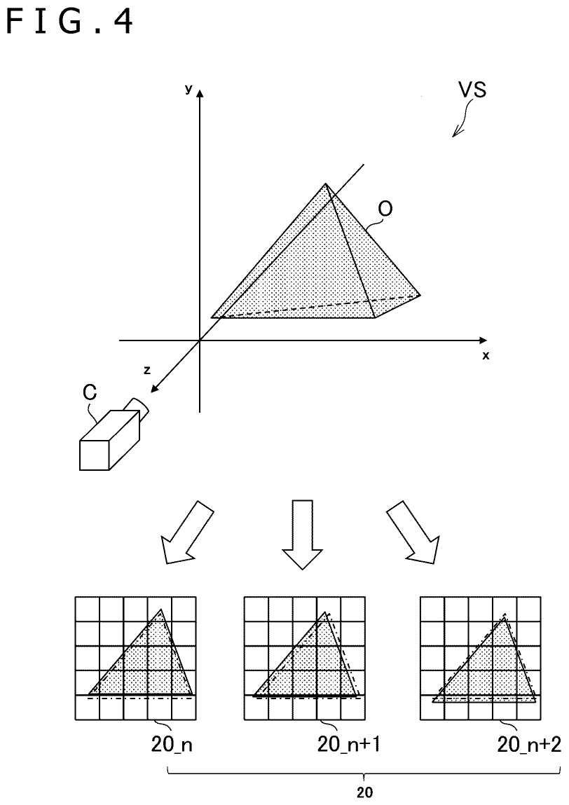

The processing target frame can be said to be an image indicating, from a predetermined viewpoint, a virtual space VS in which the abovementioned one or more game objects represented by 3D data are arranged (see FIG. 4). The processing target frame is generated every predetermined time. Each of the generated processing target frames is once stored in the storage section 12 and then subjected to subsequent processing, instead of being displayed on the display section 18 without any change. Note that, in the following description, processing targeting an n-th processing target frame 20_n is mainly illustrated, but similar processing is also executed on other processing target frames (that is, n=2, 3, . . . , N).

Here, in the present implementation, the image quality of a frame does not simply correspond to the pixel count (resolution). The image quality of a frame may, for example, be evaluated in reference to each of the level of the signal/noise (SN) ratio, the level of reproducibility of a spatial frequency, the level of time stability (the amount of artifact and flickering that occur at the time when a plurality of frames are sequentially displayed), and the like in comparison to a reference frame or a comprehensive consideration of these factors.

### (2) Acquisition of Intermediate Frame

The image processing system 1 acquires an intermediate frame 22_n that has an intermediate pixel count greater than the initial pixel count, in reference to the processing target frame 20_n. The intermediate pixel count is, for example, 7680×4320 (hereinafter, the pixel count is sometimes simply indicated as “8K”). The intermediate frame 22_n is generated by enlargement and interpolation processing being executed on the processing target frame 20_n.

### (3) Acquisition of Input Frame

The image processing system 1 acquires an input frame 24_n that has, for each pixel, channels (information elements) greater in number than the channels which the intermediate frame 22_n has for each pixel and that has an input pixel count smaller than the intermediate pixel count, in reference to the intermediate frame 22_n and auxiliary information 30_n to be described later. The input pixel count is, for example, 3840×2160 (4K). Note that a channel refers to various kinds of information elements that define the pixel value of each pixel of a frame. For example, a frame having three channels is an image including color information (RGB) in each pixel.

### (4) Acquisition of Estimated Frame

The image processing system 1 inputs the input frame 24_n to a machine learning model 200 and acquires an estimated frame 26_n. The estimated frame 26_n is an image having an estimated pixel count that is equal to the input pixel count and an estimated image quality that is equal to or greater than the initial image quality.

Note that the machine learning model 200 is a model that has learned with use of a plurality of pieces of training data each including a learning input frame and a learning estimated frame.

### (5) Acquisition of Accumulated Feature Information

The machine learning model 200 includes an accumulated feature information output layer 202 that receives, as input, an (n−1)-th input frame 24_n−1 and that outputs (n−1)-th accumulated feature information 28_n−1 indicating the features of the first through (n−1)-th input frames 24 (see FIG. 2).

The image processing system 1 acquires the (n−1)-th accumulated feature information 28_n−1 . The acquired (n−1)-th accumulated feature information 28_n−1 is input to an estimated frame output layer 204, and an (n−1)-th estimated frame 26_n−1 is output from the estimated frame output layer 204 (see FIG. 2). Note that the acquired (n−1)-th accumulated feature information 28_n−1 is also stored in the storage section 12 and offered for estimation of an estimated frame 26_n that corresponds to the next processing target frame (n-th processing target frame) 20_n.

### (6) Acquisition of Auxiliary Information

As described above, the (n−1)-th accumulated feature information 28_n−1 is information indicating the features of the first through (n−1)-th input frames 24 (hence, the first through (n−1)-th processing target frames 20). Using the (n−1)-th accumulated feature information 28_n−1, in which pieces of information regarding the past processing target frames 20 are accumulated, for estimation of an n-th estimated frame 26_n increases the amount of information available for estimation, allowing a high quality estimated frame 26_n to be obtained.

However, when any motion or the like of the displayed game object is made between the (n−1)-th processing target frame 20_n−1 and the n-th processing target frame 20_n, if the n-th input frame 24_n and the (n−1)-th accumulated feature information 28_n−1 are input to the machine learning model 200 without any change, such a phenomenon (what is generally called a ghost phenomenon) that an afterimage of the game object that had been displayed in the (n−1)-th processing target frame 20_n−1 is displayed may occur.

In view of this, the image processing system 1 applies various kinds of correction that are described later and based on the information (motion vector, depth buffer, and the like) obtained at the time of rendering to the (n−1)-th accumulated feature information 28_n−1, and thereby acquires (n−1)-th auxiliary information 30_n−1 (see FIG. 2).

As described above, according to the image processing system 1, the estimated frame 26 is estimated with use of auxiliary information 30 that is based on the accumulated feature information 28 in which pieces of past information are accumulated, in addition to the input frame 24 corresponding to the current processing target frame 20. This increases the amount of information available for estimation, allowing a high quality estimated frame 26_n to be obtained.

### 3. Functions Implemented By Image Processing System

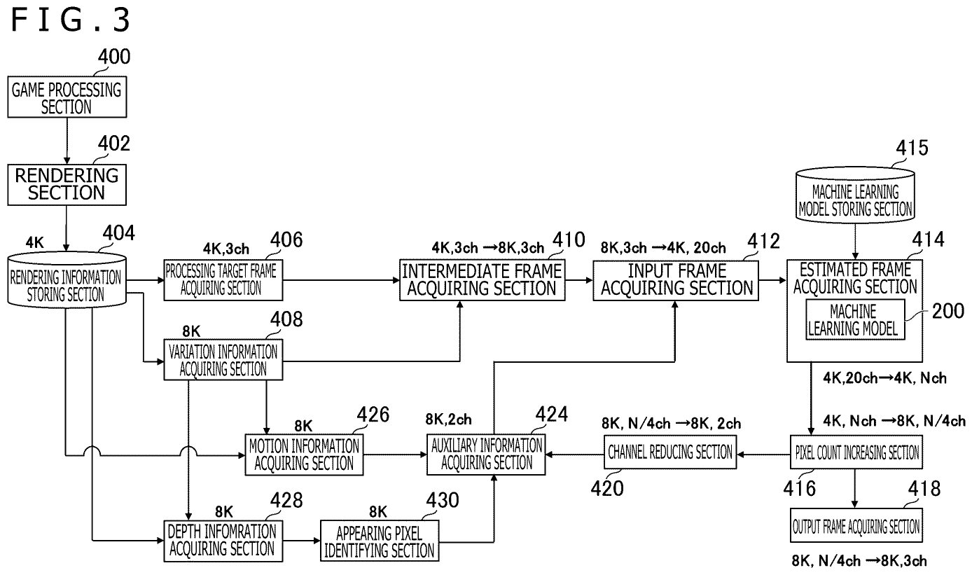

FIG. 3 is a functional block diagram illustrating an example of functions implemented by the image processing system 1. Note that, in FIG. 3, the increase and decrease in the pixel count and the number of channels is illustrated for each block indicating each function. For example, the input frame acquiring section 412 illustrated in FIG. 3 represents that a process to reduce the pixel count from 8K to 4K but increase the number of channels from three (3 ch) to 20(20 ch) is to be performed.

As illustrated in FIG. 3, in the image processing system 1, a game processing section 400, a rendering section 402, a rendering information storing section 404, a processing target frame acquiring section 406, a variation information acquiring section 408, an intermediate frame acquiring section 410, an input frame acquiring section 412, an estimated frame acquiring section 414, a machine learning model storing section 415, a pixel count increasing section 416, an output frame acquiring section 418, a channel reducing section 420, an auxiliary information acquiring section 424, a motion information acquiring section 426, a depth information acquiring section 428, and an appearing pixel identifying section 430 are implemented.

The game processing section 400, the rendering section 402, the processing target frame acquiring section 406, the variation information acquiring section 408, the intermediate frame acquiring section 410, the input frame acquiring section 412, the estimated frame acquiring section 414, the pixel count increasing section 416, the output frame acquiring section 418, the channel reducing section 420, the auxiliary information acquiring section 424, the motion information acquiring section 426, the depth information acquiring section 428, and the appearing pixel identifying section 430 are mainly implemented by the control section 10. The rendering information storing section 404 and the machine learning model storing section 415 are mainly implemented by the storage section 12. Note that the game processing section 400, the rendering section 402, and the rendering information storing section 404 are functions provided by game software.

### Game Processing Section

The game processing section 400 executes various kinds of processing related to a game. The game processing section 400 executes, for example, processing of arranging a game object O in the virtual space VS, processing of causing the game object O to make an action or move, and processing of changing a viewpoint C for viewing the virtual space VS, according to the game program executed by the control section 10 and user input received by the operation section 16 (see FIG. 4). The game object O includes a primitive such as a polygon indicated by 3D data. The 3D data includes geometric information indicating the positions of the vertices or the like, phase information indicating how to connect the vertices, and attribute information such as color.

### Rendering Section

FIG. 4 is a diagram describing processing in the rendering section 402. The rendering section 402 generates first through N-th (N is a natural number equal to or greater than 2) processing target frames 20 by executing rendering (drawing process) of 3D data indicating one or more game objects O as viewed from the predetermined viewpoint C. The processing target frame 20 can also be said to be an image indicating, from the predetermined viewpoint C, the virtual space VS in which one or more game objects O represented by 3D data are arranged. The processing target frame 20 has a predetermined initial pixel count.

The rendering section 402 executes rendering according to the results of various kinds of processing executed in the game processing section 400. Specifically, the rendering section 402 executes vertex processing (vertex shading) and pixel processing (pixel shading) in reference to 3D data indicating the game objects O arranged in the virtual space VS.

The vertex processing includes a coordinate conversion process (perspective projection) of converting the coordinate system from a view coordinate system to a screen coordinate system. To a perspective projection matrix (camera matrix) used for the coordinate conversion process, numerical values related to the variation in the viewpoint C are added, as described later. The rendering section 402 may execute rendering in reference to light source information, depth information (depth buffer), texture information, normal line information, and the like.

Here, the rendering section 402 generates each processing target frame 20 by executing rendering in such a manner that the viewpoint C varies for each processing target frame 20. In this instance, even if the game processing section 400 fixes the viewpoint C to a predetermined position, the rendering section 402 varies the viewpoint C for each processing target frame 20. As a result, as illustrated in FIG. 4, in each of the processing target frames 20_n, 20_n+1, and 20_n+2, the position of the displayed game object O varies. In other words, the rendering section 402 is applying jitter at the time of generating each processing target frame 20. Specifically, the rendering section 402 varies the viewpoint C for each processing target frame 20 by adding a numerical value that corresponds to the size of less than one pixel and that is different for each processing target frame 20 to the perspective projection matrix. As such a rule, for example, a Halton sequence is available.

### Rendering Information Storing Section

The rendering information storing section 404 stores information necessary for rendering processing in the rendering section 402 and information obtained as a result of the rendering processing.

### Processing Target Frame Acquiring Section

The processing target frame acquiring section 406 acquires each of the first through N-th processing target frames 20. Specifically, the processing target frame acquiring section 406 acquires each of the first through N-th processing target frames 20 that are stored in the rendering information storing section 404.

### Variation Information Acquiring Section

The variation information acquiring section 408 acquires variation information stored in the rendering information storing section 404. Variation information is information indicating the amount by which the viewpoint C has varied through the variation. The information indicating the amount of variation may also be said to be a variation vector indicating the direction and distance of variation. For example, the information indicating the amount of variation in the viewpoint C is included in the Halton sequence described above, and may hence be used as the variation information.

### Intermediate Frame Acquiring Section

The intermediate frame acquiring section 410 acquires each of the first through N-th intermediate frames 22 by generating, in reference to each of the processing target frames 20, intermediate frames 22 that correspond to the respective processing target frames 20 and have an intermediate pixel count greater than the initial pixel count. That is, each intermediate frame 22 is an image obtained by enlarging the processing target frame 20 corresponding to the relevant intermediate frame 22. Specifically, the intermediate pixel count is 8K. Note that the details of generation of the intermediate frames 22 are described later.

### Input Frame Acquiring Section

The input frame acquiring section 412 acquires each of the first through N-th input frames 24 by generating, in reference to each of the intermediate frames 22 and each auxiliary information 30, input frames 24 that correspond to the respective intermediate frames 22 and have an input pixel count smaller than the intermediate pixel count. Each input frame 24 is an image obtained by reducing the intermediate frame 22 corresponding to the relevant input frame 24. Specifically, the input pixel count is 4K. Note that details of generation of the input frames 24 are described later.

### Motion Information Acquiring Section

The motion information acquiring section 426 acquires (n−1)-th motion information which is information indicating the amount and direction of motion from the (n−1)-th processing target frame 20_n−1 to the n-th processing target frame 20_n. The (n−1)-th motion information is, specifically, image information indicating the amount and direction of motion of each pixel made between the (n−1)-th processing target frame 20_n−1 and the n-th processing target frame 20_n. Motion information is also called a motion vector.

Motion information is preferably increased in pixel count with use of the abovementioned variation information and a method similar to the method of acquiring the intermediate frame 22 by enlarging the processing target frame 20. Hence, motion information is preferably image information (information in bitmap format) having a pixel count of 8K that is equal to the intermediate pixel count. The motion information acquiring section 426 specifically acquires original motion information having a pixel count equal to the initial pixel count, and executes enlargement and interpolation processing on the original motion information by using variation information having a pixel count equal to the intermediate pixel count, to acquire motion information having pixels equal in number to the intermediate pixel count.

### Depth Information Acquiring Section

The depth information acquiring section 428 acquires (n−1)-th depth information indicating the depth of each pixel in the (n−1)-th processing target frame 20_n−1 and n-th depth information indicating the depth of each pixel in the n-th processing target frame 20_n. Depth information is also called a depth buffer or a Z buffer.

Depth information is preferably increased in pixel count, in reference to the abovementioned variation information, by a method similar to the method of acquiring the intermediate frame 22 by enlarging the processing target frame 20. Hence, depth information is preferably image information (information in bitmap format) having a pixel count of 8K that is equal to the intermediate pixel count. Specifically, the depth information acquiring section 428 acquires original depth information having a pixel count equal to the initial pixel count, and executes enlargement and interpolation processing on the original depth information by using variation information having a pixel count equal to the intermediate pixel count, to acquire depth information having pixels equal in number to the intermediate pixel count.

### Appearing Pixel Identifying Section

The appearing pixel identifying section 430 identifies an n-th appearing pixel that is among the pixels in the n-th processing target frame 20_n and that is a pixel in which a whole or part of a game object O that is not displayed in the (n−1)-th processing target frame 20_n−1 is displayed, in reference to the (n−1)-th depth information and the n-th depth information. Specifically, the appearing pixel identifying section 430 identifies the n-th appearing pixel in reference to a difference between the (n−1)-th depth information and the n-th depth information. Note that the appearing pixel identifying section 430 may identify the n-th appearing pixel in reference to an (n−1)-th perspective projection matrix related to the (n−1)-th processing target frame 20_n−1 and an n-th perspective projection matrix related to the n-th processing target frame 20_n. Further, the appearing pixel identifying section 430 may identify the n-th appearing pixel by using the variation information and the motion information. Note that, more specifically, the appearing pixel identifying section 430 identifies the n-th appearing pixel and generates n-th appearing pixel information which is image information indicating the position of the n-th appearing pixel.

### Machine Learning Model

The machine learning model 200 is a model that estimates an n-th estimated frame 26_n in reference to the n-th input frame 24_n. The machine learning model 200 is specifically a convolutional neural network (CNN). As the machine learning model 200, for example, known models including ResNet of a multilayer structure including a residual connection mechanism, U-Net of what is called an encoder/decoder type, and the like are available. As the machine learning model 200, the model described in NPL 1 may be used.

The machine learning model 200 is a model that has learned with use of a plurality of pieces of training data each including a learning input frame having an input pixel count and a learning estimated frame having an estimated pixel count. Various kinds of known techniques including backpropagation are available for learning of the machine learning model 200.

Specifically, the machine learning model 200 includes the accumulated feature information output layer 202, the estimated frame output layer 204, and a convolution layer 206 (see FIG. 2).

The accumulated feature information output layer 202 receives, as input, the n-th input frame 24_n and the (n−1)-th auxiliary information 30_n−1 that is based on the (n−1)-th accumulated feature information 28_n−1 indicating the features of the first through (n−1)-th input frames 24, and outputs the n-th accumulated feature information 28_n indicating the features of the first through n-th input frames 24_n. The accumulated feature information output layer 202 may, for example, include one or more convolution layers.

The accumulated feature information 28_n−1 is image information (information in bitmap format) having a pixel count equal to the input pixel count. The accumulated feature information 28_n−1 can be said to be a feature map indicating the features of the first through (n−1)-th input frames 24.

Note that the accumulated feature information output layer 202 receives, as input, the first input frame 24_1 and given auxiliary information and outputs the first accumulated feature information 28_1. In the case of n=1, since there have been no accumulated feature information 28 and auxiliary information 30, given auxiliary information prepared in advance is input to the accumulated feature information output layer 202, together with the first input frame 24_1.

The estimated frame output layer 204 receives, as input, the n-th accumulated feature information 28_n, and outputs the n-th estimated frame 26_n. The estimated frame output layer 204 may, similarly to the accumulated feature information output layer 202, include one or more convolution layers, for example. Alternatively, the estimated frame output layer 204 may include one or more transposed convolution layers (deconvolution layers).

The convolution layer 206 is a layer that reduces the number of channels of the accumulated feature information 28 while maintaining the pixel count thereof. The accumulated feature information 28 output from the convolution layer 206 is offered for processing in the auxiliary information acquiring section 424. The convolution layer 206 can reduce the dimensions of the accumulated feature information 28, thus achieving lower computation costs. The convolution layer 206 is, for example, a convolution layer with a kernel count of 1×1, but is not limited thereto.

### Machine Learning Model Storing Section

The machine learning model storing section 415 stores the machine learning model 200. Specifically, the machine learning model storing section 415 stores the parameters of the machine learning model 200 (the number of convolution layers, the number of nodes used for each convolution layer, the weight of each node, and the like).

### Estimated Frame Acquiring Section

The estimated frame acquiring section 414 inputs the n-th input frame 24_n to the machine learning model 200 and acquires the n-th estimated frame 26_n. In the present implementation, the estimated frame 26 has an estimated pixel count that is equal to the input pixel count. Specifically, the estimated pixel count is 4K.

### Pixel Count Increasing Section

The pixel count increasing section 416 increases the pixel count of each of the estimated frame 26 and the accumulated feature information 28 output from the machine learning model 200. Note that the pixel count is preferably increased by such a method as bilinear interpolation.

Here, in the present implementation, since the input pixel count of the input frame 24 is 4K, the estimated frame 26 and the accumulated feature information 28 are also acquired as information having a pixel count of 4K. The pixel count increasing section 416 increases the pixel count of each of the estimated frame 26 and the accumulated feature information 28 from 4K to 8K. With the estimated frame 26 having a pixel count of 8K, high quality display corresponding to the display is enabled as described later. Moreover, with the accumulated feature information 28 having the pixel count of 8K, auxiliary information 30 having a pixel count of 8K can be acquired as described later.

In the pixel count increasing section 416, the number of channels needs to be reduced to perform interpolation for the increase in the amount of information associated with the increase in the pixel count. When the pixel count is increased from 4K to 8K, the pixel count is four times that of the previous count. Hence, in the present implementation, the information that is output from the machine learning model 200 and has N channels is reduced to ¼. That is, in association with increasing the pixel count by the pixel count increasing section 416, the number of channels of the estimated frame 26 and the accumulated feature information 28 is reduced to N/4.

### Output Frame Acquiring Section

The output frame acquiring section 418 acquires an output frame, in reference to the estimated frame 26 whose pixel count has been increased by the pixel count increasing section 416. The output frame is an image corresponding to the display form of the display that is the display section 18. The output frame acquiring section 418 includes, for example, a convolutional layer and preferably reduces the number of channels of the estimated frame 26 by convolutional processing. Specifically, the output frame acquiring section 418 preferably generates and acquires an output frame that has a pixel count of 8K and three channels.

### Channel Reducing Section

The channel reducing section 420 reduces the number of channels of the accumulated feature information 28 whose pixel count has been increased by the pixel count increasing section 416. Specifically, the channel reducing section 420 includes, for example, a convolutional layer and preferably reduces the number of channels of the accumulated feature information 28 from N/4 to two by convolutional processing.

### Auxiliary Information Acquiring Section

The auxiliary information acquiring section 424 causes motion compensation to be applied to the (n−1)-th accumulated feature information 28_n−1 in reference to the (n−1)-th motion information and acquires the (n−1)-th auxiliary information 30_n−1. Motion compensation refers to processing of, for example, moving a pixel in the (n−1)-th accumulated feature information 28_n−1 from a position x to a position x′, in a case where a pixel that had been present at the position x in the (n−1)-th processing target frame 20_n−1 moves to the position x′ in the n-th processing target frame 20_n (see FIG. 4). More specifically, the auxiliary information acquiring section 424 acquires the (n−1)-th auxiliary information 30_n−1 by setting the pixel value of each of the one or more pixels in the (n−1)-th accumulated feature information 28_n−1 for the pixel at a position to which movement has been made in accordance with the amount and direction of motion of the pixel, in reference to the (n−1)-th motion information.

In a case where any motion of the game object O has been made between the n-th processing target frame 20_n and the (n−1)-th processing target frame 20_n−1, if the n-th input frame 24_n and the (n−1)-th accumulated feature information 28_n−1 are input to the machine learning model 200 without any change at the time of acquiring the n-th estimated frame 26_n, a ghost phenomenon in which an afterimage of the game object O which had been displayed in the past frame is displayed may occur in the n-th estimated frame 26_n that is output. In view of this, in the image processing system 1, as described above, the (n−1)-th auxiliary information 30_n−1 is acquired by causing motion compensation to be applied to the (n−1)-th accumulated feature information 28_n−1 in reference to the (n−1)-th motion information. This can restrain the abovementioned ghost phenomenon from occurring.

Further, the auxiliary information acquiring section 424 generates and acquires auxiliary information 30 that has a pixel count of 8K, in reference to the motion information, the appearing pixel, and the accumulated feature information 28 that each have a pixel count of 8K. As described above, generating auxiliary information 30 in reference to high resolution information makes it possible to effectively use spatial information of past frames.

### Generation of Intermediate Frames And Input Frames

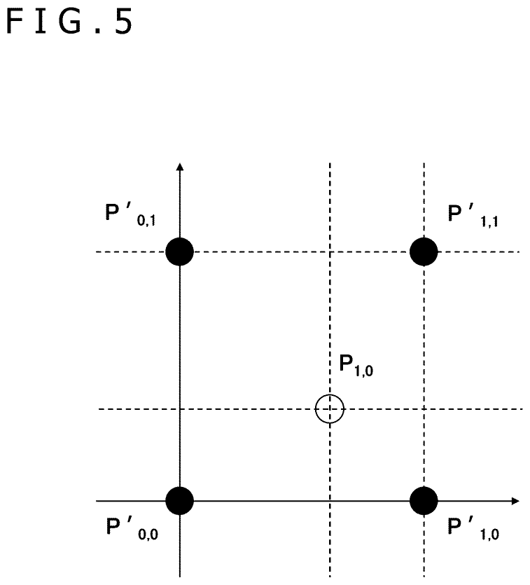

FIG. 5 is a diagram describing processing in the intermediate frame acquiring section 410. FIG. 5 illustrates a case in which an n-th intermediate frame 22_n is acquired. For example, as illustrated in FIG. 5, supposing that the pixel center of a pixel in the intermediate frame 22_n which is intended to be acquired is P1, 0, _k the intermediate frame acquiring section 410 obtains the pixel value of P1, 0 by bilinear interpolation, according to the coordinates and pixel values of each of the pixel centers P′0, 0, P′1, 0, P′0, 1, and P′1, 1 of the four pixels closest to P1, 0 in the intermediate frame 22_n. Here, P′1, 0 is at a position deviated from P1, 0 by an amount of variation indicated by the variation information. Pixel values of pixels newly generated by the enlargement processing are also similarly obtained. Note that, as the method of interpolation, in addition to bilinear interpolation, various kinds of known techniques including bicubic interpolation, Lanczos interpolation, and the like are available.

When rendering is executed in such a manner that the viewpoint C varies for each processing target frame 20, the amount of time-series information increases. Using the frames obtained by enlarging the processing target frames 20 obtained in such a manner for estimation makes it possible to obtain an estimated frame 26 of higher quality.

Meanwhile, when the frame obtained by enlarging the processing target frame 20 that is obtained by executing rendering in such a manner that the viewpoint C varies is input to the machine learning model 200 without any change, the influence of variation in the viewpoint C can result in lower estimation accuracy.

In view of this, in the image processing system 1, as described above, pixel values of positions corresponding to pre-variation pixels in the relevant processing target frame 20 are obtained by interpolation in reference to the variation information and pixels of each processing target frame 20, so that each intermediate frame 22 is generated, and each input frame 24 generated in reference to each intermediate frame 22 is input to the machine learning model 200. This corrects the influence of variation in the viewpoint C, making it possible to restrain the estimation accuracy from lowering.

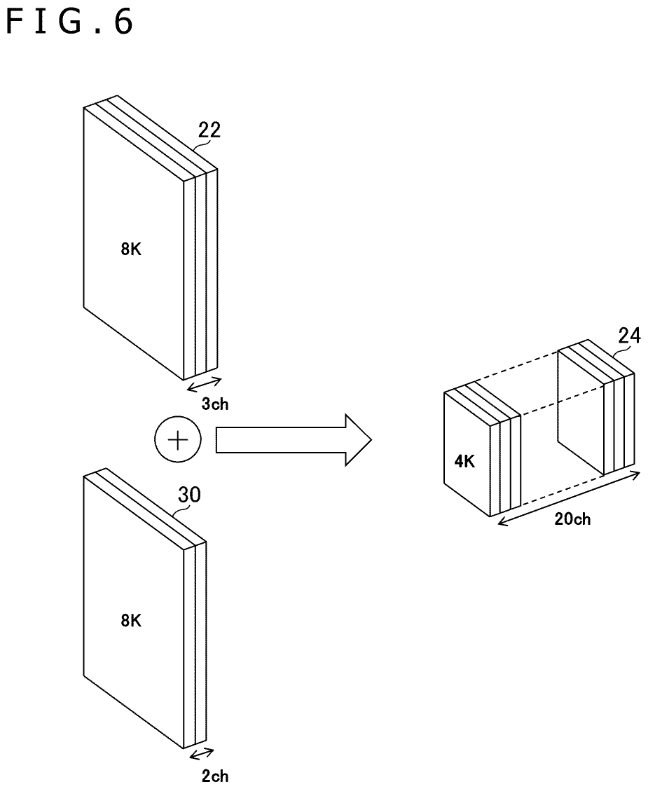

FIG. 6 is a diagram schematically describing generation of an input frame in the input frame acquiring section. The input frame acquiring section 412 generates and acquires an input frame 24 in reference to an intermediate frame 22 and the auxiliary information 30. The intermediate frame 22 is an image of 8K, as described above. Further, the number of channels of the intermediate frame 22 generated in reference to the processing target frame 20 is three.

Further, the accumulated feature information 28 that has undergone processing in the pixel count increasing section 416 and the channel reducing section 420 as described above is now information that has a pixel count of 8K and two channels. Hence, the auxiliary information acquiring section 424 acquires auxiliary information 30 that has a pixel count of 8K and two channels, in reference to the motion information, an appearing pixel count, and the accumulated feature information 28.

The input frame acquiring section 412 generates a frame that has a pixel count of 8K and five (2+3) channels, in reference to the auxiliary information 30 and the intermediate frame 22. Further, the input frame acquiring section 412 reduces the pixel count of the generated frame. Information can now be allocated to the number of channels by the amount of decrease in the pixel count. That is, the number of channels can be increased without the total amount of information being increased or decreased. Specifically, the input frame acquiring section 412 acquires an input frame 24 that has a pixel count of 4K and 20 channels.

Moreover, as illustrated in FIG. 3, from the machine learning model 200 to which an input frame 24 that has a pixel count of 4K and 20 channels has been input, accumulated feature information 28 that has a pixel count of 4K and N channels (N is a natural number less than 20) is output. By subjecting this accumulated feature information 28 to processing by the pixel count increasing section 416 and the channel reducing section 420, auxiliary information 30 that has a pixel count of 8K and two channels as described above can be generated.

### 4. Processing Executed In Image Processing System

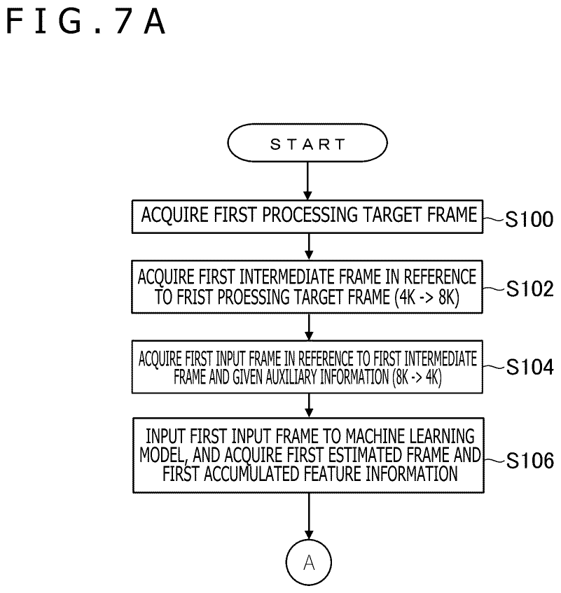

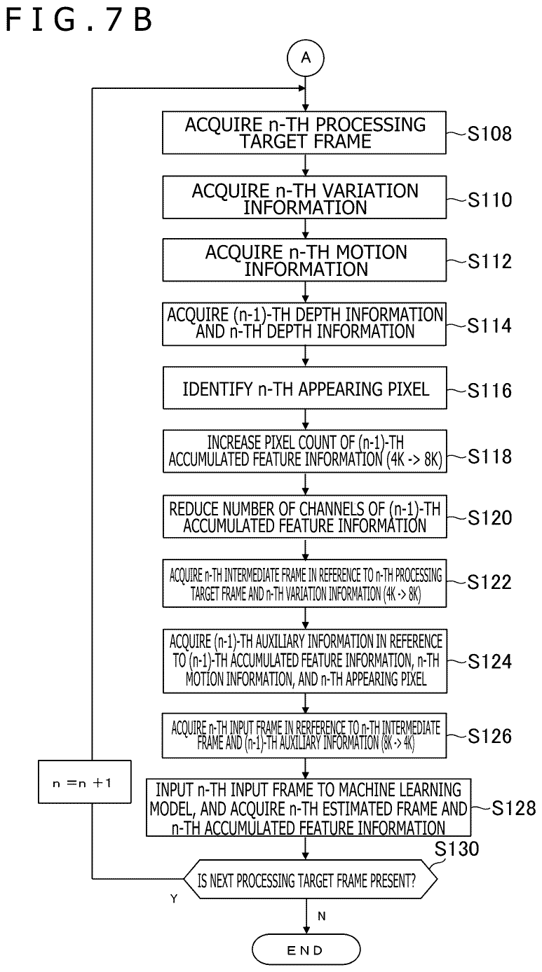

FIGS. 7A and 7B are each a flowchart illustrating an example of a flow of processing executed in the image processing system 1. The processing illustrated in FIGS. 7A and 7B is executed by the control section 10 operating in accordance with a program stored in the storage section 12. Note that FIG. 7A illustrates processing when n=1, while FIG. 7B illustrates processing when n=_2or more.

### (1) Processing When N=1

First, the control section 10 acquires a first processing target frame 20_1 (S100). The control section 10 then acquires a first intermediate frame 22_1 in reference to the first processing target frame 20_1 (S102). At this time, the pixel count of the frame is increased. Specifically, the control section 10 acquires a first intermediate frame 22_1 that has a pixel count of 8K, in reference to the first processing target frame 20_1 that has a pixel count of 4K.

The control section 10 then acquires a first input frame 24_1 in reference to the first intermediate frame 22_1 and given auxiliary information (S104). At this time, the pixel count of the frame is reduced. Specifically, the control section 10 acquires a first input frame 24_1 that has a pixel count of 4K, in reference to the first intermediate frame 22_1 that has a pixel count of 8K and given auxiliary information.

Next, the control section 10 inputs the first input frame 24_1 to the machine learning model 200 and acquires a first estimated frame 26_1 and first accumulated feature information 28_1 (S106).

(2) Processing when n≥2

The control section 10 acquires an n-th processing target frame 20_n (S108). Next, the control section 10 acquires n-th variation information (S110). Subsequently, the control section 10 acquires n-th motion information (S112). Thereafter, the control section 10 acquires (n−1)-th depth information and n-th depth information (S114) and identifies an n-th appearing pixel in reference to the (n−1)-th depth information and the n-th depth information (S116).

Then, the control section 10 increases the pixel count of the acquired (n−1)-th accumulated feature information (S118). Specifically, the control section 10 increases the pixel count of the (n−1)-th accumulated feature information from 4K to 8K. Further, the control section 10 reduces the number of channels of the (n−1)-th accumulated feature information (S120).

The control section 10 then acquires an n-th intermediate frame in reference to the n-th processing target frame 20_n and the n-th variation information (S122). At this time, the control section 10 increases the pixel count of the frame. Specifically, the control section 10 specifically acquires an n-th intermediate frame 22_n that has a pixel count of 8K, in reference to the n-th processing target frame 20_n that has a pixel count of 4K.

Further, the control section 10 acquires (n−1)-th auxiliary information 30_n−1 in reference to the (n−1)-th accumulated feature information, the n-th motion information, and the n-th appearing pixel (S124).

The control section 10 then acquires an n-th input frame 24_n in reference to the n-th intermediate frame 22_n and the (n−1)-th auxiliary information 30_n−1 (S126). At this time, the control section 10 reduces the pixel count of the frame. Specifically, the control section 10 acquires an n-th input frame 24_n that has a pixel count of 4K, in reference to the n-th intermediate frame 22_n that has a pixel count of 8K and the (n−1)-th auxiliary information 30_n−1.

Subsequently, the control section 10 inputs the n-th input frame 24_n to the machine learning model 200 and acquires the n-th estimated frame 26_n and the n-th accumulated feature information 28_n (S128).

Then, the control section 10 determines whether or not the next frame is present (S130). In the case of determining that the next frame is present (S130:Y), the control section 10 increments the value to n=n+1 and repeats the processing in S108 through S128. In the case of determining that the next frame is not present (S130:N), the control section 10 ends the processing.

### 5. Summary

The image processing system 1 according to the present implementation described above estimates an n-th estimated frame 26_n with use of (n−1)-th accumulated feature information 28_n−1 indicating the features of first through (n−1)-th input frames 24. That is, in addition to information regarding the n-th processing target frame 20_n, information regarding the first through (n−1)-th processing target frames 20 can be used, so that the amount of information available for estimation is increased, making it possible to obtain a high quality estimated frame 26_n.

Moreover, in the present implementation, the number of channels of the input frame 24 that is to be input to the machine learning model 200 is increased with use of the auxiliary information 30 regarding past frames, improving time-series stability. Further, making the auxiliary information 30 have a pixel count of 8K allows effective use of spatial information regarding past frames. In the manner described above, the image processing system 1 can improve time-series stability while maintaining spatial accuracy.

Note that, in the present implementation, an example in which the pixel count of each of the processing target frame 20 and the input frame 24 is 4K and the pixel count of the intermediate frame 22 is 8K has been described, but the pixel count of each frame is not limited to this example. For example, the pixel count of each of the processing target frame 20 and the input frame 24 may be 2K, and the pixel count of the intermediate frame 22 may be 4K. In this case, the variation information, the motion information, and the appearing pixel, for example, are also preferably information having a pixel count (4K) corresponding to that of the intermediate frame 22.

The number of channels of each frame described with reference to FIG. 3 and other relevant drawings is also an example, and is not limited to the number described in the present implementation. At least, the number of channels of the auxiliary information 30 is preferably used to increase the number of channels of the input frame 24.

### 6. Supplement

For example, the image processing system can also have the following configurations.
(1)

An image processing system that inputs first through n-th input frames (n is a natural number equal to or greater than 2) to a machine learning model and acquires first through n-th estimated frames, including:
at least one processor, in which the at least one processor
   acquires each of first through n-th processing target frames,
   acquires (n−1)-th accumulated feature information that indicates features of the first through (n−1)-th input frames and that is output from the machine learning model,
   acquires (n−1)-th auxiliary information in reference to the (n−1)-th accumulated feature information, and
   acquires the n-th input frame that has, for each pixel, information elements greater in number than information elements that the n-th processing target frame has for each pixel, in reference to the n-th processing target frame and the (n−1)-th auxiliary information.
(2)

The image processing system according to (1), in which the n-th input frame has an input pixel count smaller than a pixel count of the (n−1)-th auxiliary information.
(3)

The image processing system according to (1) or (2), in which the at least one processor acquires an n-th intermediate frame that has an intermediate pixel count greater than a predetermined initial pixel count, in reference to the n-th processing target frame that has the initial pixel count, and
acquires the n-th input frame in reference to the n-th intermediate frame and the (n−1)-th auxiliary information.
(4)

The image processing system according to (3), in which the at least one processor
acquires the n-th processing target frame by rendering a three-dimensional virtual space in such a manner that a predetermined viewpoint varies,
acquires n-th variation information that is information related to variation in the viewpoint of the n-th processing target frame in the rendering and that has a pixel count greater than the initial pixel count, and
acquires the n-th intermediate frame in reference to the n-th processing target frame and the n-th variation information.
(5)

The image processing system according to (4), in which the at least one processor acquires the (n−1)-th auxiliary information in reference to at least the n-th variation information and the (n−1)-th accumulated feature information.
(6)

The image processing system according to (5), in which the at least one processor acquires n-th motion information that indicates an amount and a direction of motion from the (n−1)-th processing target frame to the n-th processing target frame and that has a pixel count equal to a pixel count of the n-th variation information, in reference to the (n−1)-th processing target frame, the n-th processing target frame, and the n-th variation information, and
acquires the (n−1)-th auxiliary information in reference to at least the n-th motion information and the (n−1)-th accumulated feature information.

(7)

The image processing system according to (5) or (6), in which the at least one processor acquires (n−1)-th depth information that indicates a depth of each pixel in the (n−1)-th processing target frame and that has a pixel count equal to a pixel count of (n−1)-th variation information, in reference to the (n−1)-th processing target frame and the (n−1)-th variation information,
acquires n-th depth information that indicates a depth of each pixel in the n-th processing target frame and that has a pixel count equal to the pixel count of the n-th variation information, in reference to the n-th processing target frame and the n-th variation information,
identifies an n-th appearing pixel that is among pixels in the n-th processing target frame and that is a pixel in which a whole or part of an object that is not displayed in the (n−1)-th processing target frame is displayed, in reference to the (n−1)-th depth information and the n-th depth information, and
acquires the (n−1)-th auxiliary information by causing a pixel value of the n-th appearing pixel in the (n−1)-th accumulated feature information to be replaced with a predetermined value.
(8)

The image processing system according to any one of (2) to (7), in which the at least one processor
acquires one of the estimated frames that is output as a result of a corresponding one of the input frames being input to the machine learning model and that has an estimated pixel count equal to the input pixel count, and
acquires an output frame by converting the estimated pixel count and the number of information elements for each pixel in the estimated fame in such a manner that the estimated pixel count and the number of information elements correspond to a display format of display means.

What is claimed is:

1. An image processing system that inputs first through n-th input frames, n being a natural number equal to or greater than 2, to a machine learning model and obtaining first through n-th estimated frames, comprising:
one or more computer processors; and
one or more non-transitory computer-readable media that store instructions which, when executed by the one or more computer processors, cause the one or more computer processors to perform operations comprising:
obtaining each of first through n-th processing target frames,
obtaining (n−1)-th accumulated feature information that indicates features of the first through (n−1)-th input frames and that is output from the machine learning model,
obtaining (n−1)-th auxiliary information in reference to the (n−1)-th accumulated feature information, and
obtaining the n-th input frame that has, for each pixel, information elements greater in number than information elements that the n-th processing target frame has for each pixel, in reference to the n-th processing target frame and the (n−1)-th auxiliary information.

2. The image processing system of claim 1, wherein the n-th input frame has an input pixel count smaller than a pixel count of the (n−1)-th auxiliary information.

3. The image processing system according to claim 1, wherein the operations comprise:
obtaining an n-th intermediate frame that has an intermediate pixel count greater than a predetermined initial pixel count, in reference to the n-th processing target frame that has the initial pixel count, and
obtaining the n-th input frame in reference to the n-th intermediate frame and the (n−1)-th auxiliary information.

4. The image processing system of claim 3, wherein the operations comprise:
obtaining the n-th processing target frame by rendering a three-dimensional virtual space in such a manner that a predetermined viewpoint varies,
obtaining n-th variation information that is information related to variation in the viewpoint of the n-th processing target frame in the rendering and that has a pixel count greater than the initial pixel count, and
obtaining the n-th intermediate frame in reference to the n-th processing target frame and the n-th variation information.

5. The image processing system of claim 4, wherein the operations comprise obtaining the (n−1)-th auxiliary information in reference to at least the n-th variation information and the (n−1)-th accumulated feature information.

6. The image processing system of claim 5, wherein the operations comprise:
obtaining n-th motion information that indicates an amount and a direction of motion from the (n−1)-th processing target frame to the n-th processing target frame and that has a pixel count equal to a pixel count of the n-th variation information, in reference to the (n−1)-th processing target frame, the n-th processing target frame, and the n-th variation information, and
obtaining the (n−1)-th auxiliary information in reference to at least the n-th motion information and the (n−1)-th accumulated feature information.

7. The image processing system of claim 5, wherein the operations comprise:
obtaining (n−1)-th depth information that indicates a depth of each pixel in the (n−1)-th processing target frame and that has a pixel count equal to a pixel count of (n−1)-th variation information, in reference to the (n−1)-th processing target frame and the (n−1)-th variation information,
obtaining n-th depth information that indicates a depth of each pixel in the n-th processing target frame and that has a pixel count equal to the pixel count of the n-th variation information, in reference to the n-th processing target frame and the n-th variation information, identifies an n-th appearing pixel that is among pixels in the n-th processing target frame and that is a pixel in which a whole or part of an object that is not displayed in the (n−1)-th processing target frame is displayed, in reference to the (n−1)-th depth information and the n-th depth information, and
obtaining the (n−1)-th auxiliary information by causing a pixel value of the n-th appearing pixel in the (n−1)-th accumulated feature information to be replaced with a predetermined value.

8. The image processing system according to claim 2, wherein the operations comprise:
obtaining one of the estimated frames that is output as a result of a corresponding one of the input frames being input to the machine learning model and that has an estimated pixel count equal to the input pixel count, and
obtaining an output frame by converting the estimated pixel count and the number of information elements for each pixel in the estimated frame in such a manner that the estimated pixel count and the number of information elements correspond to a display format of a display.

9. One or more non-transitory computer-readable media that store instructions for inputting first through n-th input frames, n being a natural number equal to or greater than 2, to a machine learning model and obtaining first through n-th estimated frames, the instructions, when executed by the one or more computer processors, cause the one or more computer processors to perform operations comprising:
obtaining each of first through n-th processing target frames,
obtaining (n−1)-th accumulated feature information that indicates features of the first through (n−1)-th input frames and that is output from the machine learning model,
obtaining (n−1)-th auxiliary information in reference to the (n−1)-th accumulated feature information, and
obtaining the n-th input frame that has, for each pixel, information elements greater in number than information elements that the n-th processing target frame has for each pixel, in reference to the n-th processing target frame and the (n−1)-th auxiliary information.

10. The media of claim 9, wherein the n-th input frame has an input pixel count smaller than a pixel count of the (n−1)-th auxiliary information.

11. The media of claim 9, wherein the operations comprise:
obtaining an n-th intermediate frame that has an intermediate pixel count greater than a predetermined initial pixel count, in reference to the n-th processing target frame that has the initial pixel count, and
obtaining the n-th input frame in reference to the n-th intermediate frame and the (n−1)-th auxiliary information.

12. The media of claim 11, wherein the operations comprise:
obtaining the n-th processing target frame by rendering a three-dimensional virtual space in such a manner that a predetermined viewpoint varies,
obtaining n-th variation information that is information related to variation in the viewpoint of the n-th processing target frame in the rendering and that has a pixel count greater than the initial pixel count, and
obtaining the n-th intermediate frame in reference to the n-th processing target frame and the n-th variation information.

13. The media of claim 12, wherein the operations comprise obtaining the (n−1)-th auxiliary information in reference to at least the n-th variation information and the (n−1)-th accumulated feature information.

14. The media of claim 13, wherein the operations comprise:
obtaining n-th motion information that indicates an amount and a direction of motion from the (n−1)-th processing target frame to the n-th processing target frame and that has a pixel count equal to a pixel count of the n-th variation information, in reference to the (n−1)-th processing target frame, the n-th processing target frame, and the n-th variation information, and
obtaining the (n−1)-th auxiliary information in reference to at least the n-th motion information and the (n−1)-th accumulated feature information.

15. The media of claim 13, wherein the operations comprise:
obtaining (n−1)-th depth information that indicates a depth of each pixel in the (n−1)-th processing target frame and that has a pixel count equal to a pixel count of (n−1)-th variation information, in reference to the (n−1)-th processing target frame and the (n−1)-th variation information,
obtaining n-th depth information that indicates a depth of each pixel in the n-th processing target frame and that has a pixel count equal to the pixel count of the n-th variation information, in reference to the n-th processing target frame and the n-th variation information, identifies an n-th appearing pixel that is among pixels in the n-th processing target frame and that is a pixel in which a whole or part of an object that is not displayed in the (n−1)-th processing target frame is displayed, in reference to the (n−1)-th depth information and the n-th depth information, and
obtaining the (n−1)-th auxiliary information by causing a pixel value of the n-th appearing pixel in the (n−1)-th accumulated feature information to be replaced with a predetermined value.

16. The media of claim 10, wherein the operations comprise:
obtaining one of the estimated frames that is output as a result of a corresponding one of the input frames being input to the machine learning model and that has an estimated pixel count equal to the input pixel count, and
obtaining an output frame by converting the estimated pixel count and the number of information elements for each pixel in the estimated frame in such a manner that the estimated pixel count and the number of information elements correspond to a display format of a display.

17. A computer-implemented method for inputting first through n-th input frames, n being a natural number equal to or greater than 2, to a machine learning model and obtaining first through n-th estimated frames, method comprising:
obtaining each of first through n-th processing target frames,
obtaining (n−1)-th accumulated feature information that indicates features of the first through (n−1)-th input frames and that is output from the machine learning model,
obtaining (n−1)-th auxiliary information in reference to the (n−1)-th accumulated feature information, and
obtaining the n-th input frame that has, for each pixel, information elements greater in number than information elements that the n-th processing target frame has for each pixel, in reference to the n-th processing target frame and the (n−1)-th auxiliary information.

18. The method of claim 17, wherein the n-th input frame has an input pixel count smaller than a pixel count of the (n−1)-th auxiliary information.

19. The method of claim 17, comprising:
obtaining an n-th intermediate frame that has an intermediate pixel count greater than a predetermined initial pixel count, in reference to the n-th processing target frame that has the initial pixel count, and
obtaining the n-th input frame in reference to the n-th intermediate frame and the (n−1)-th auxiliary information.

20. The method of claim 19, comprising:
obtaining the n-th processing target frame by rendering a three-dimensional virtual space in such a manner that a predetermined viewpoint varies,
obtaining n-th variation information that is information related to variation in the viewpoint of the n-th processing target frame in the rendering and that has a pixel count greater than the initial pixel count, and
obtaining the n-th intermediate frame in reference to the n-th processing target frame and the n-th variation information.
